(19) United States
(12) Patent Application Publication
(10) Pub. No.: US 2015/0373792 A1
(43) Pub. Date: Dec. 24, 2015

(54) LIGHT EMITTING DIODE (LED) DRIVING DEVICE AND LIGHTING APPARATUS INCLUDING THE SAME

(71) Applicant: SAMSUNG ELECTRONICS CO., LTD., Suwon-si (KR)

(72) Inventors: Chang Seob KIM, Seoul (KR); Kyu Cheol KANG, Suwon-si (KR)

(73) Assignee: SAMSUNG ELECTRONICS CO., LTD., Suwon-si (KR)

(21) Appl. No.: 14/587,676

(22) Filed: Dec. 31, 2014

(30) Foreign Application Priority Data
Jun. 18, 2014 (KR) 10-2014-0074067

(51) Int. Cl. H05B 33/08

(52) U.S. Cl. CPC H05B 33/0809; H05B 33/083

(57) ABSTRACT

A light emitting diode (LED) driving device includes a rectifier configured to rectify alternating current power to generate rectified power, an AC driver configured to control respective operations of the plurality of LED groups based on a voltage of the rectified power, and a controller configured to control an operation of the AC driver based on a control command received through a digital addressable lighting interface (DALI) communications protocol, and operate based on the rectified power received as driving power.

### CROSS-REFERENCE TO RELATED APPLICATION

This application claims priority from Korean Patent Application No. 10-2014-0074067, filed on Jun. 18, 2014, in the Korean Intellectual Property Office, the disclosure of which is incorporated herein by reference in its entirety.

### BACKGROUND

1. Field

Apparatuses consistent with exemplary embodiments relate to a light emitting diode (LED) driving device and a lighting apparatus including the same.

2. Description of the Related Art

Light emitting diodes (LEDs) are extensively used as light sources, due to properties such as lower power consumption, higher luminance, and the like. Recently, light emitting devices using LEDs are employed in general illumination devices and backlight units for larger sized liquid crystal displays. The light emitting devices are provided in the form of packages, which facilitates the installation thereof in various apparatuses.

### SUMMARY

One or more exemplary embodiments provide a lighting system capable of controlling an operation of a light emitting diode (LED) through wireless controlling, while driving the LED using alternating current (AC) power without an AC-DC (Direct Current) converter.

According to an aspect of an exemplary embodiment, a light emitting diode (LED) driving device for driving a plurality of LED groups may include a rectifier configured to rectify alternating current power to generate rectified power, an AC driver configured to control respective operations of the plurality of LED groups based on a voltage of the rectified power, and a controller configured to control an operation of the AC driver based on a control command received through a digital addressable lighting interface (DALI) communications protocol, and operate based on the rectified power received as driving power.

The LED driving device may further include a voltage dropper being configured to lower a voltage of the rectified power to be supplied as the driving power.

The AC driver may compare a voltage of the rectified power to one or more threshold voltages within a single period of the rectified power and may control respective operations of the plurality of LED groups according to a result of the comparison.

The controller may control light output from the plurality of LED groups by controlling the one or more threshold voltages.

The controller may divide the single period of the rectified power into a plurality of sections based on comparison between the voltage of the rectified power and the one or more threshold voltages, and may control light output from the plurality of LED groups by adjusting respective intervals of the plurality of sections.

The AC driver may increase a number of turned-on LED groups among the plurality of LED groups when the voltage of the rectified power is increased within a single period of the rectified power and may decrease the number of turned-on LED groups among the plurality of LED groups when the voltage of the rectified power is decreased within the single period of the rectified power.

The AC driver may increase a number of turned-on LED groups connected to one another in series, among the plurality of LED groups, when the voltage of the rectified power is increased within a single period of the rectified power, and may increase the number of turned-on LED groups connected to one another in parallel, among the plurality of LED groups, when the voltage of the rectified power is decreased within the single period of the rectified power.

The plurality of LED groups may include a first LED group and a second LED group having different levels of light output therefrom when the same amount of a current is applied to the first and second LED groups, and the first LED group may have a higher level of light output therefrom than that of the second LED group.

The AC driver may turn on the first LED group and the second LED group on when the voltage of the rectified power is increased within a single period of the rectified power, and may turn on the first LED group and turn off the second LED group when the voltage of the rectified power is decreased within the single period of the rectified power.

The AC driver may connect the first LED group and the second LED group to each other in series and turn on the first and second LED groups when the voltage of the rectified power is increased within a single period of the rectified power, and may connect the first LED group and the second LED group to each other in parallel and turns on the first and second LED groups when the voltage of the rectified power is decreased within the single period of the rectified power.

According to an aspect of another exemplary embodiment, a light emitting diode (LED) driving device for driving a plurality of LED groups may include a rectifier configured to rectify alternating current (AC) power to generate rectified power, an AC driver configured to control respective operations of the plurality of LED groups based on a voltage of the rectified power, and generate a predetermined direct current power, and a controller configured to control an operation of the AC driver based on a control command received through a DALI communications protocol, and operate based on the direct current power received as driving power.

The LED driving device may further include a charger being charged by the direct current power. The controller may operate based on an output from the charger which is supplied as the driving power.

The AC driver may compare a voltage of the rectified power to one or more threshold voltages within a single period of the rectified power and may control respective operations of the plurality of LED groups according to a result of the comparison.

The controller may control light output from the plurality of LED groups by controlling the one or more threshold voltages.

According to an aspect of still another exemplary embodiment, a lighting apparatus may include a light emitting unit including a plurality of LED groups, and an LED driving device being configured to drive the plurality of LED groups by using alternating current (AC) power, wherein the LED driving device includes an AC driver including a plurality of switching elements connected to at least one of the plurality of LED groups, and a switching controller configured to control the plurality of switching elements based on comparison between a voltage of a rectified power generated by rectifying the AC power and one or more threshold voltages, and a controller configured to control the switching controller based on a control command received through a DALI communications protocol, and operate based on the rectified power received as driving power.

The switching controller may control the plurality of switching elements based on comparison between the voltage of the rectified power and the one or more threshold voltages in a single period of the rectified power.

The AC driver may divide the single period of the rectified power into a plurality of sections based on comparison between the voltage of the rectified power and the one or more threshold voltages.

The switching controller may set a number of the switching elements that are turned-on in each of the plurality of sections.

The switching controller may turn on a different set of the switching elements in each of the plurality of sections.

The switching controller may determine a number of the LED groups being turned-on by controlling the switching elements.

### BRIEF DESCRIPTION OF DRAWINGS

The above and other aspects will be more apparent by describing certain exemplary embodiments in conjunction with the accompanying drawings, in which:

FIGS. 1 to 3 are block diagrams of a light emitting diode (LED) driving device according to exemplary embodiments;

FIGS. 4 and 5 are block diagrams of an LED driving device according to other exemplary embodiments;

FIG. 6 is a waveform diagram illustrating operations of an LED driving device according to an exemplary embodiment;

FIGS. 7A to 8D are circuit diagrams illustrating a connection structure of a plurality of LED groups according to operations of an LED driving device according to exemplary embodiments;

FIGS. 9 and 10 illustrate LED packages applied to a lighting apparatus including an LED driving device according to an exemplary embodiment; and

FIG. 11 is an exploded perspective view illustrating a lighting apparatus including an LED driving device according to an exemplary embodiment.

### DETAILED DESCRIPTION

Exemplary embodiments will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

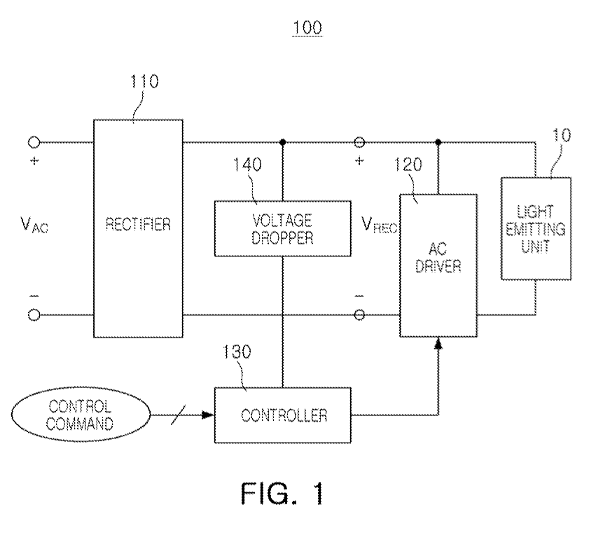

FIGS. 1 to 3 are block diagrams of a light emitting diode (LED) driving device according to exemplary embodiments.

With reference to FIG. 1, an LED driving device 100 according to an exemplary embodiment may include a rectifier 110, an alternating current (AC) driver 120, a controller 130, a voltage dropper 140, and the like. The rectifier 110 may receive commercially available AC power V_{AC} and generate rectified power V_{REC}, and may include a diode bridge circuit. The LED driving device 100 illustrated in FIG. 1 may be included, together with a light emitting unit 10 having a plurality of LED groups, in a lighting apparatus.

The rectified power V_{REC} output by the rectifier 110 may be directly applied to the light emitting unit 10 without a procedure of conversion into direct current (DC) power by an AC-DC converter or the like. The light emitting unit 10 may include a plurality of LED groups, and turn-on and turn-off of respective LED groups may be determined depending on a change in a voltage of the rectified power V_{REC} in a single period of the rectified power V_{REC}. The turn-on and turn-off of the plurality of respective LED groups may be determined and performed by the AC driver 120.

In the LED driving device 100 according to an exemplary embodiment, an LED may be operated by the AC driver 120 using the rectified power V_{REC}. Based on characteristics of the rectified power V_{REC} having a voltage increased or decreased in a single period, the AC driver 120 may adjust the number of LEDs which are turned on according to a voltage of the rectified power V_{REC}. For example, the AC driver 120 may divide a voltage of the rectified power V_{REC} into several sections within a single period and may turn on a relatively large number of LEDs in a section in which the voltage of the rectified power V_{REC} is relatively high.

The controller 130 may control operations of the AC driver 120, and as an example, may receive a control command provided externally, based on a digital addressable lighting interface (DALI) communications protocol. Operations of the AC driver 120 may be controlled by the control command received by the controller 130 according to the DALI communications protocol. For example, the controller 130 may receive a control command for a reservation operation and set a time at which the AC driver 120 allows the light emitting unit 10 to emit light, or may receive a control command for brightness control and control the brightness of the light emitting unit 10 controlled by the AC driver 120. According to an exemplary embodiment, the controller 130 may include a microcontroller capable of receiving and analyzing a control command based on the DALI communications protocol.

The controller 130 may include a plurality of active elements, and thus, to operate the controller 130, a predetermined amount of driving power may be needed. In the LED driving device 100 according to an exemplary embodiment, driving power for operating the controller 130 may be supplied through the rectified power V_{REC}. The rectified power V_{REC} may be used as the driving power or may be lowered by the voltage dropper 140 and used as the driving power. Although the voltage dropper 140 is illustrated as a module separate from the controller 130 in FIG. 1, it should be noted that the voltage dropper 140 and the controller 130 may be implemented as a single module.

The controller 130 may be connected to an external controller via a DALI bus to receive a control command according to the DALI communications protocol. The controller 130 may be connected to the external controller through a 2-line interface, and according to the DALI protocol, which is a half-duplex scheme digital communications protocol, a signal transmitted and received between the external controller and the controller 130 may include forward frame data and backward frame data. The forward frame data may include a total of 19 bit data, and the 19 bit data may contain address information of the AC driver 120 to be controlled, command information corresponding to a command to be controlled, and the like.

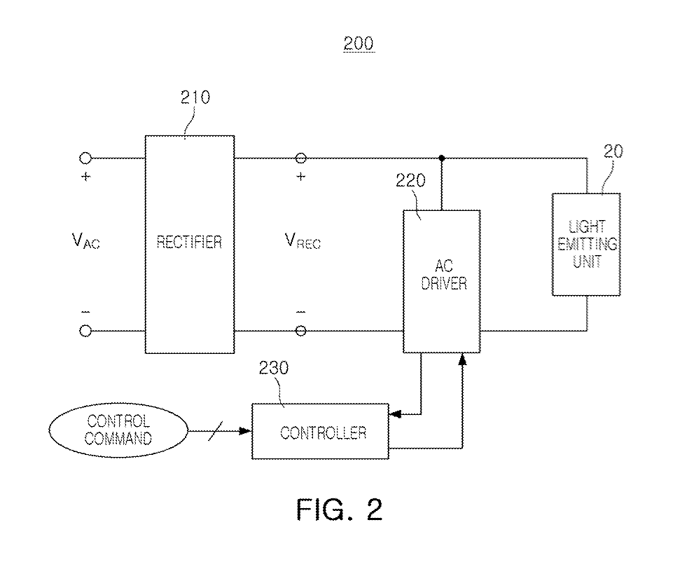

With reference to FIG. 2, an LED driving device 200 according to an exemplary embodiment may include a rectifier 210, an alternating current (AC) driver 220, and a controller 230. The rectifier 210 may receive commercially available AC power V_{AC} and output rectified power V_{REC}, and the rectified power V_{REC} may be directly transferred to the light emitting unit 20 without a procedure of conversion into direct current (DC) power and used as driving power for a plurality of LED groups. The LED driving device 200 illustrated in FIG. 2 may be included, together with the light emitting unit 20 having a plurality of LED groups, in a lighting apparatus.

The AC driver 220 may perform control so that the plurality of LED groups included in the light emitting unit 20 may receive the rectified power V_{REC} and are operated. In an exemplary embodiment, the AC driver 220 may change a connection structure of the plurality of LED groups included in the light emitting unit 20, instead of controlling characteristics of the rectified power V_{REC} input to the light emitting unit 20, to secure stabilized light output operation of the light emitting unit 20.

In an exemplary embodiment, the AC driver 220 may connect the plurality of LED groups to one another in series when a voltage of the rectified power V_{REC} is increased in a single period of the rectified power V_{REC}, and may connect the plurality of LED groups to one another in parallel when a voltage of the rectified power V_{REC} is decreased in a single period of the rectified power V_{REC}. In another exemplary embodiment, the AC driver 220 may increase the number of turned-on LED groups among the plurality of LED groups when the voltage of the rectified power V_{REC} is increased within a single period of the rectified power V_{REC}. On the other hand, for example, when the voltage of the rectified power V_{REC} is decreased within a single period of the rectified power V_{REC}, the AC driver 220 may reduce the number of turned-on LED groups among the plurality of LED groups.

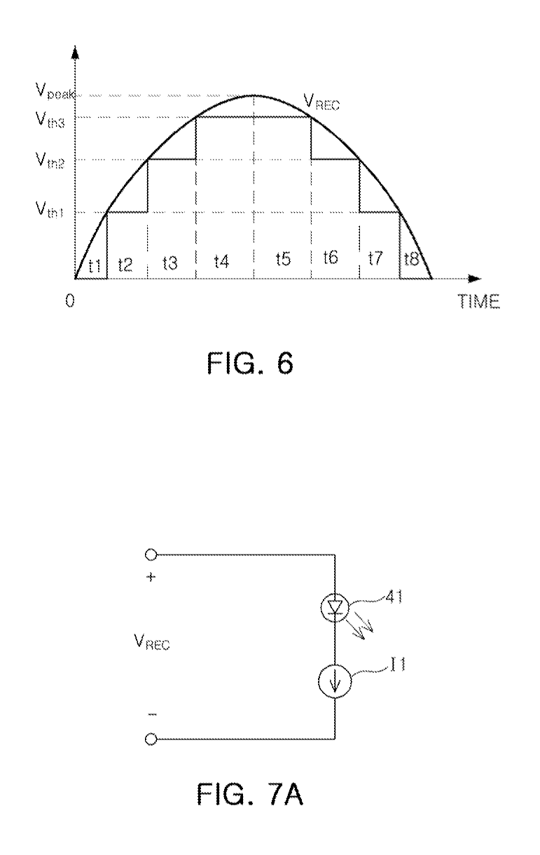

In an exemplary embodiment in which the number of the turned-on LED groups is changed according to an increase or a decrease in a voltage of the rectified power V_{REC}, the LED groups may have different levels of light output. For example, a level of light output from the respective LED group may be in proportion to a time at which the respective LED group is turned on within a single period of the rectified power V_{REC}. In other words, the LED group that is turned on for a longest period of time among the plurality of LED groups within a single of the rectified power V_{REC} may have the highest level of light output. In this manner, luminance deviations that may occur by allowing LEDs to emit light using the rectified power V_{REC} having AC characteristics may be significantly reduced, which will be described below with reference to FIG. 6.

In an exemplary embodiment illustrated in FIG. 2, the controller 230 may receive a control command transferred externally according to the DALI communications protocol, and may control operations of the AC driver 220, based on the received control command. The controller 230 may include a microcontroller capable of receiving and analyzing the control command according to the DALI communications protocol. Therefore, to operate the controller 230, a predetermined amount of driving power may be needed, and in an exemplary embodiment, driving power may be supplied by the AC driver 220 to operate the controller 230. For example, in an exemplary embodiment, one of voltages generated inside the AC driver 220 may be supplied as driving power to the controller 230.

In consideration of characteristics of LEDs operating in a constant current scheme, a constant current control circuit connected to the respective LED groups of the light emitting unit 20 may be included in the AC driver 220. To control a current applied to the respective LED groups according to a voltage of the rectified power V_{REC} increased or decreased within a single period of the rectified power V_{REC}, the constant current circuit may receive a predetermined reference voltage. In this case, the reference voltage input to the constant current control circuit may be different according to the magnitude of a current needed for the operation of the respective LED groups, and the controller 230 may receive the reference voltage as driving power.

The control command received by the controller 230 according to the DALI communications protocol may contain address information of the light emitting unit 20 to be controlled and information for controlling of a light emission operation of the light emitting unit 20, similar to the embodiment illustrated in FIG. 1. The controller 230 may control reservation for a light emission time, brightness, turn-on and turn-off of the light emitting unit 20, and the like, based on the information contained in the control command.

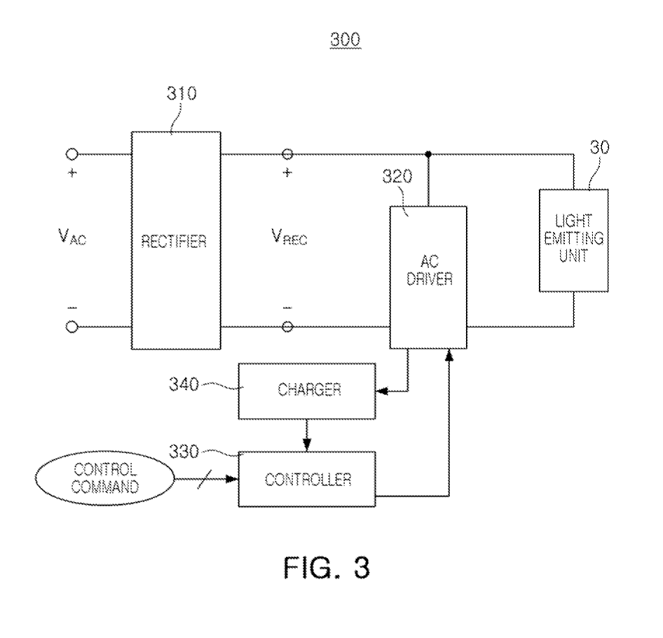

With reference to FIG. 3, an LED driving device 300 according to an exemplary embodiment may include a rectifier 310, an alternating current (AC) driver 320, and a controller 330. The rectifier 310 may receive commercially available AC power V_{AC} and output rectified power V_{REC}, and the rectified power V_{REC} may be directly transferred to the light emitting unit 30 without a procedure of conversion into direct current (DC) power to be used as driving power for a plurality of LED groups. The LED driving device 300 illustrated in FIG. 3 may be included, together with the light emitting unit 30 having a plurality of LED groups, in a lighting apparatus.

The AC driver 320 may control so that the plurality of LED groups included in the light emitting unit 30 may receive the rectified power V_{REC} and are operated. In an exemplary embodiment, the AC driver 320 may change a connection structure of the plurality of LED groups included in the light emitting unit 30 or may adjust the number of turned-on LED groups, instead of controlling characteristics of the rectified power V_{REC} input to the light emitting unit 30, to secure a stabilized light output operation of the light emitting unit 30. The operations of the AC driver 320 in the exemplary embodiment of FIG. 3 may be similar to the operations of the AC drivers 120 and 220 included in the LED driving devices 100 and 200 of FIGS. 1 and 2, respectively.

In an exemplary embodiment, the controller 330 may control operations of the AC driver 320 using a control command received according to the DALI communications protocol. The controller 330 may include a microcontroller capable of analyzing the control command according to the DALI communications protocol to control operations of the AC driver 320. Therefore, to operate the controller 330, a predetermined amount of driving power may be needed.

With reference to FIG. 3, driving power of the controller 330 according to an exemplary embodiment may be supplied from a charger 340 charged by the AC driver 320. The charger 340 may be charged by the AC driver 320 and may include a battery supplying a predetermined level of direct current power to the controller 330.

In the LED driving device 300 according to an exemplary embodiment disclosed with reference to FIG. 3, the AC driver 320 may control operations of the plurality of LED groups included in the light emitting unit 30 according to an increase or a decrease in a voltage of the rectified power V_{REC} in a single period of the rectified power V_{REC}. The AC driver 320 may adjust the number of turned-on LED groups among the plurality of LED groups according to an increase or a decrease in a voltage of the rectified power V_{REC} within a single period or may change a connection structure of the plurality of LED groups.

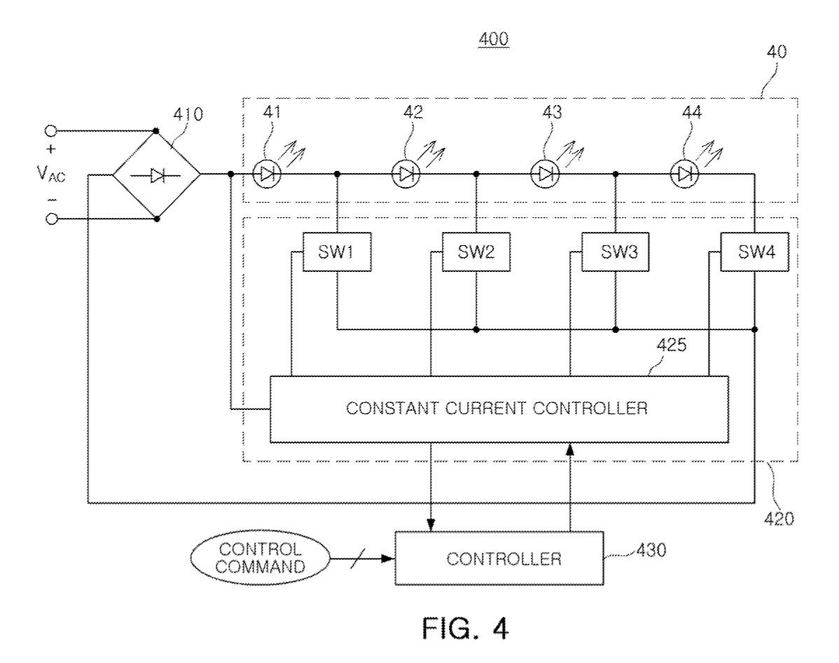

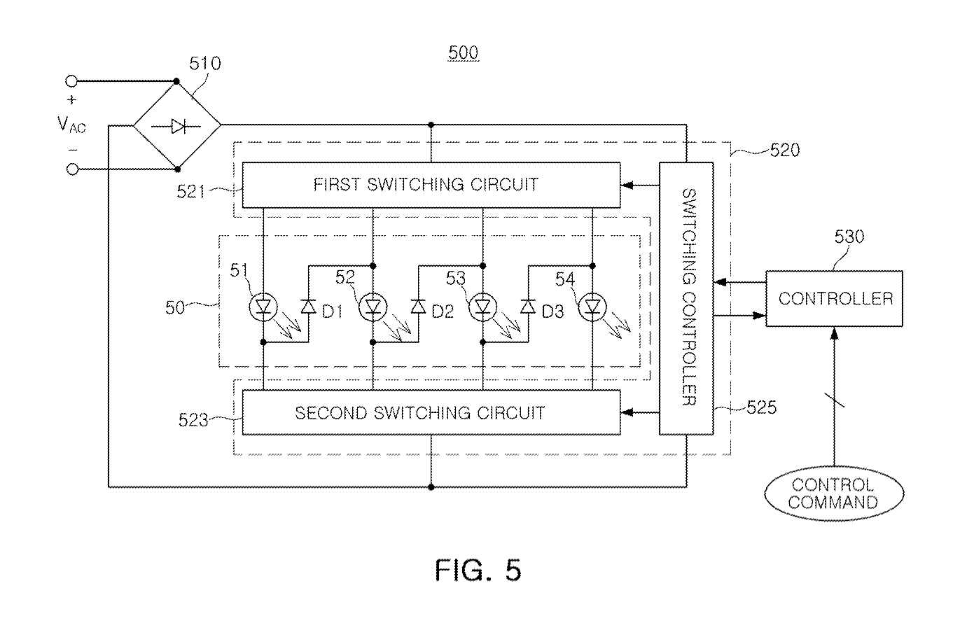

FIGS. 4 and 5 are block diagrams of an LED driving device according to other exemplary embodiments. LED driving devices 400 and 500 illustrated in FIGS. 4 and 5 may be included in a lighting apparatus, together with light emitting units 40 and 50 including a plurality of LED groups 41, 42, 43, and a plurality of LED groups 51, 52, 53 and 54, respectively.

With reference to FIG. 4, an LED driving device 400 may include a rectifier 410 receiving and rectifying commercially available AC power V_{AC}, an AC driver 420 and a controller 430 controlling operations of a light emitting unit 40 according to an output from the rectifier 410, and the like. The light emitting unit 40 may include a plurality of LED groups 41, 42, 43 and 44, and switching elements SW1, SW2, SW3 and SW4 may be connected to nodes among the LED groups 41, 42, and 44. Operations of the respective switching elements SW1, SW2, SW3 and SW4 may be determined by a constant current controller 425.

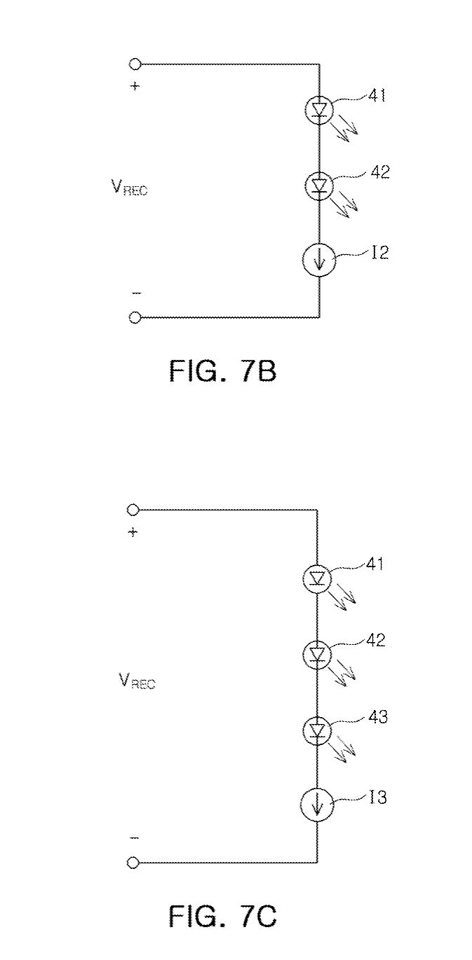

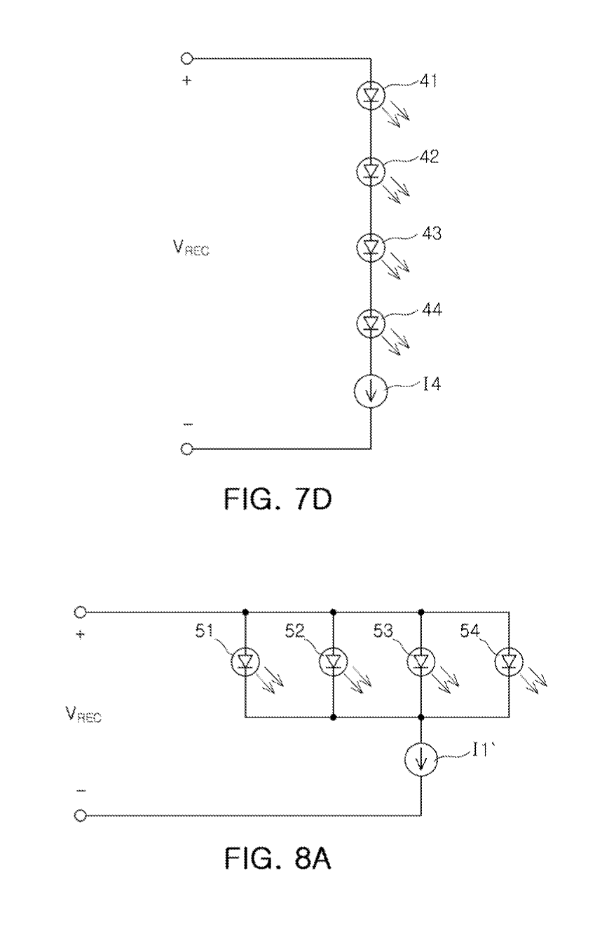

The constant current controller 425 may determine turn-on and turn-off of the respective switching elements SW1, SW2, SW3 and SW4 according to a voltage of rectified power output by the rectifier 410. The voltage of the rectified power may increase or decrease within a single period of the rectified power. The constant current controller 425 may turn off a portion of the switching elements SW1, SW2, SW3 and SW4 such that a relatively small number of LED groups 41, 42, 43 and 44 are turned on when a voltage of the rectified power is relatively low. On the other hand, the constant current controller 425 may control operations of the switching elements SW1, SW2, SW3 and SW4 such that a relatively large number of LED groups 41, 42, 43 and 44 are turned on when a level of the rectified power is relatively high. The control operations of the switching elements SW1, SW2, SW3 and SW4 by the constant current controller 425 and operations of the respective LED groups 41, 42, 43 and 44 performed thereby will be described with reference to FIG. 6 to FIG. 7D.

The controller 430 may control operations of the constant current controller 425, based on a control command received according to the DALI communications protocol. According to an exemplary embodiment, by controlling, at the constant current control circuit 425, a duty ratio at which the respective switching elements SW1, SW2, SW3 and SW4 are turned on and turned off, the controller 430 may adjust a level of light output from the light emitting unit 40.

Although FIG. 4 illustrates that one controller 430 controls the operation of the AC driver 420 connected to one light emitting unit 40, in another exemplary embodiment, one controller 430 may control operations of a plurality of AC drivers 420. The control command received through the DALI communications protocol may include address information allocated to the light emitting unit 40, and the controller 430 may control operations of the plurality of respective AC drivers 420 connected to the plurality of light emitting units using the address information included in the control command.

With reference to FIG. 5, an LED driving device 500 according to an exemplary embodiment may include a rectifier 510 receiving and rectifying commercially available AC power V_{AC}, an AC driver 520 and a controller 530 controlling operations of a light emitting unit 50 according to an output from the rectifier 510, and the like. The AC driver 520 may include a first switching circuit 521 and a second switching circuit 523 respectively connected to first and second nodes of the plurality of respective LED groups 51, 52, 53 and 54 included in the light emitting unit 50, and a switching controller 525 determining turn-on and turn-off of the first and second switching circuits 521 and 523.

The light emitting unit 50 may include the plurality of LED groups 51, 52, 53 and 54, and diodes D1, D2 and D3 may be connected between the LED groups 51, 52, 53 and 54, respectively. The diodes D1, D2 and D3 may be used in determining a connection structure of the LED groups 51, 52, and 54, together with the first and second switching circuits 521 and 523 respectively connected to the first and second nodes of the respective LED groups 51, 52, 53 and 54.

The connection structure of the LED groups 51, 52, and 54 may be determined by controlling the turn-on and turn-off of the switching elements included in the first and second switching circuits 521 and 523 through the switching controller 525. The switching controller 525 may control switching elements included in the first and second switching circuits 521 and 523 according to a voltage of the rectified power output by the rectifier 510. For example, when a voltage of the rectified power output by the rectifier 510 is increased to approximate a peak value, the switching controller 525 may control the switching elements included in the first and second switching circuits 521 and 523 such that the LED groups 51, 52, 53 and 54 may be connected to one another in series. On the other hand, when the voltage of the rectified power is reduced to approximate a reference potential, the switching controller 525 may perform control so that the LED groups 51, 52, 53 and 54 may be connected to one another in parallel.

The controller 530 may receive a control command transferred according to the DALI communications protocol and control operations of the switching controller 525. According to an exemplary embodiment, a level of light output from the light emitting unit 50 may be determined by a duty ratio of the switching elements included in the first and second switching circuits 521 and 523, the duty ratio being controlled by the switching controller 525. Therefore, the controller 530 may perform control such that the switching controller 525 may increase a duty ratio of the switching elements of the first and second switching circuits 521 and 523, to increase a level of light output from the light emitting unit 50, or may perform the control such that the switching controller 525 may decrease the duty ratio of the switching elements to reduce a level of light output from the light emitting unit 50. For example, the control of the connection structure of the LED groups 51, 52, 53 and 54 depending on an increase or a decrease in a voltage of the rectified power output by the rectifier 510 within a single period may be performed by the switching controller 525. The control performed regardless of a magnitude of the rectified power, for example, the control of light output from the light emitting unit 50, setting of reservation for a light emitting time of the light emitting unit 50, and the like, may be performed by the controller 530.

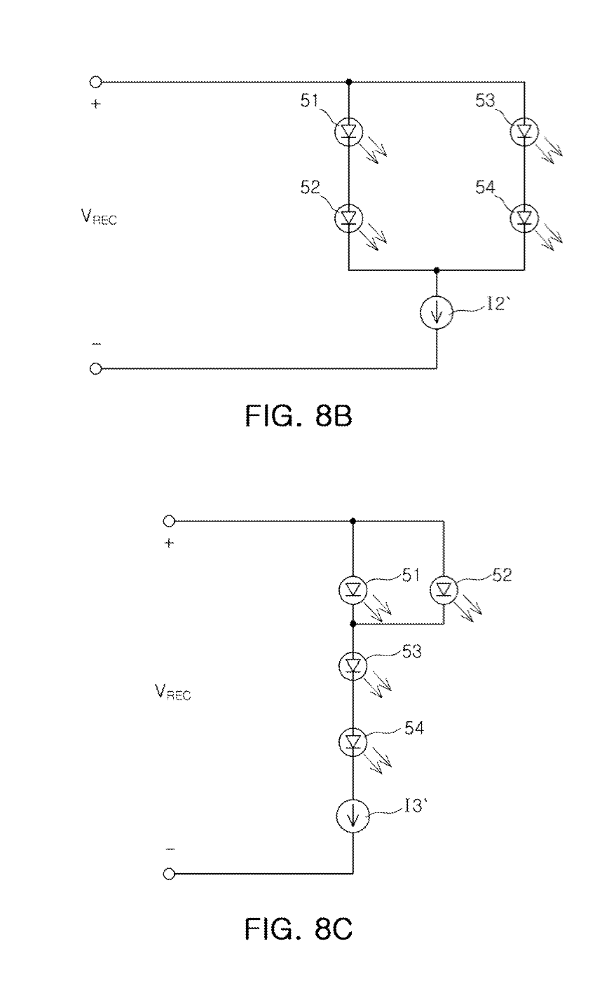

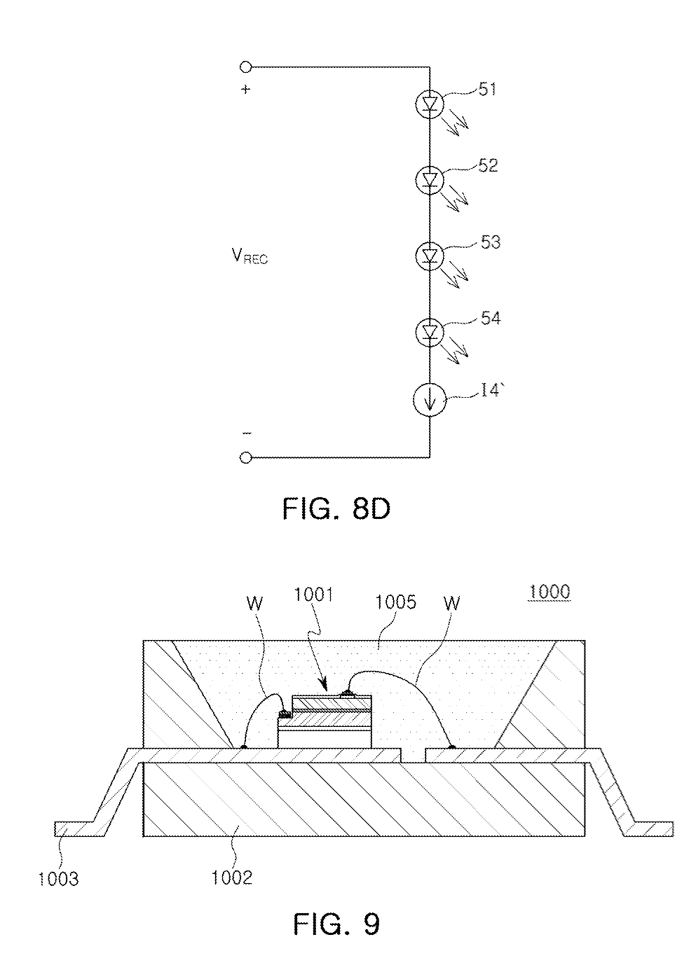

FIG. 6 is a waveform diagram illustrating operations of an LED driving device according to an exemplary embodiment, and FIGS. 7A to 8D are circuit diagrams illustrating a connection structure of a plurality of LED groups according to operations of an LED driving device according to exemplary embodiments. Operations of the LED driving devices 400 and 500 illustrated in FIGS. 4 and 5 will be described below in detail with reference to FIGS. 6 to 8D.

Operations of the LED driving device 400 illustrated in FIG. 4 will be described with reference to FIGS. 6 to 7D. Referring to FIG. 6, a single period of the rectified power V_{REC} generated by the rectifier 410 may be divided into a plurality of sections. FIG. 6 illustrates that a single period of the rectified power V_{REC} is divided into a total of 8 sections t1 to t8. However, this is only an example, and thus, exemplary embodiments are not limited thereto.

In sections t1 and t8 in which the voltage of the rectified power V_{REC} is higher than a reference potential (e.g., zero volt (0V)) and is lower than a first threshold voltage Vₜₕ₁, the constant current controller 425 may turn off second to fourth switching elements SW2, SW3 and SW4 and may turn on a first switching element SW1. Thus, in the sections t1 and t8 in which the voltage of the rectified power V_{REC} is higher than the reference potential and is lower than the first threshold voltage Vₜₕ₁, a current flows in a first LED group 41 such that the first LED group 41 may emit light.

In sections t2 and t7 in which the voltage of the rectified power V_{REC} is higher than the first threshold voltage Vₜₕ₁ and is lower than a second threshold voltage Vₜₕ₂, the constant current controller 425 may perform control so that the second switching element SW2 is turned on and the first, third and fourth switching elements SW1, SW3, and SW4 are turned off, to enable the first and second LED groups 41 and 42 to emit light. In addition, in sections t3 and t6 in which the voltage of the rectified power V_{REC} is higher than the second threshold voltage Vₜₕ₂ and is lower than a third threshold voltage Vₜₕ₃, the third switching element SW3 may be turned on and the first, second and fourth switching elements SW1, SW2, and SW4 may be turned on such that the first to third LED groups 41, 42 and 43 may emit light. In sections t4 and t5 in which the voltage of the rectified power V_{REC} is higher than the third threshold voltage Vₜₕ₃ and is lower than a peak value Vₚₑₐₖ of the voltage of the rectified power V_{REC}, the fourth switching element SW4 may be turned on and the first to third switching elements SW1, SW2 and SW3 may be turned off, such that all LED groups 41, 42, 43 and 44 may emit light.

FIGS. 7A to 7D are equivalent circuit diagrams illustrating a connection structure of a plurality of respective LED groups 41, 42, 43 and 44 according to a voltage of the rectified power V_{REC} in a single period of the rectified power V_{REC}. FIG. 7A illustrates a connection structure of the respective LED groups 41, 42, 43 and 44 in sections t1 and t8 in which the voltage of the rectified power V_{REC} is higher than the reference potential (e.g., 0V) and is lower than the first threshold voltage Vₜₕ₁. Referring to FIG. 7A, in sections t1 and t8 in which the level of the rectified power V_{REC} is higher than the reference potential 0V and is lower than the first threshold voltage Vₜₕ₁, the first switching element SW1 may be turned on such that the first LED group 41 may emit light. A current flowing in the first LED group 41 may be defined as a constant current I1.

FIG. 7B illustrates a connection structure of the respective LED groups 41, 42, 43 and 44 in sections t2 and t7 in which the voltage of the rectified power V_{REC} is higher than the first threshold voltage Vₜₕ₁ and is lower than the second threshold voltage Vₜₕ₂. Referring to FIG. 7B, in sections t2 and t7 in which the voltage of the rectified power V_{REC} is higher than the first threshold voltage Vₜₕ₁ and is lower than the second threshold voltage Vₜₕ₂, the second switching element SW2 may be turned on, such that the first and second LED groups 41 and 42 may emit light. The first and second LED groups 41 and 42 may be connected to each other in series, and a constant current flowing in the first and second LED groups 41 and 42 may be defined as a constant current I2.

FIG. 7C illustrates a connection structure of the respective LED groups 41, 42, 43 and 44, by which a constant current I3 is defined, in sections t3 and t6 in which the voltage of the rectified power V_{REC} is higher than the second threshold voltage Vₜₕ₂ and lower than the third threshold voltage Vₜₕ₃ and FIG. 7D illustrates a connection structure of the respective LED groups 41, 42, 43 and 44, by which a constant current I4 is defined, in sections t4 and t5 in which the voltage of the rectified power V_{REC} is higher than the third threshold voltage Vₜₕ₃ and lower than the peak value Vₚₑₐₖ of the voltage of the rectified power V_{REC}. As shown For example, with reference to FIGS. 6, and 7A to 7D, when the voltage of the rectified power V_{REC} is increased to approximate the peak value Vₚₑₐₖ within a single period, a relatively large number of LED groups 41, 42, 43 and 44 may be connected to one another in series and may thus emit light. On the other hand, when the voltage of the rectified power V_{REC} is reduced to approximate the reference potential (e.g., 0V) within a single period thereof, a relatively small number of LED groups 41, 42, 43 and 44 may be connected to one another in series and may thus emit light. Thus, to significantly reduce a change in light output from the light emitting unit 40 depending on a change in a voltage of the rectified power V_{REC}, the first LED group 41 may have a highest level of light output therefrom, and the fourth LED group 44 may have a lowest level of light output therefrom.

The controller 430, which controls the AC driver 420, may receive driving power for the operation thereof, from the constant current controller 425. For example, the constant current controller 425 may compare a voltage of the rectified power V_{REC} to the first to third threshold voltages Vₜₕ₁, Vₜₕ₂ and Vₜₕ₃ to control the switching elements SW1, SW2, SW3 and SW4 connected to the respective LED groups 41, 42, 43 and 44. Thus, the constant current controller 425 may include a circuit for generating the first to third threshold voltages, which are predetermined or determined according to characteristics of the rectified power V_{REC}, and the controller 430 may receive driving power generated by at least one of the first to third threshold voltages Vₜₕ₁, Vₜₕ₂, and Vₜₕ₃, to be operated.

The AC driver 420 may control operations of the respective switching elements SW1, SW2, SW3 and SW4 by comparing the first to third threshold voltages Vₜₕ₁, Vₜₕ₂ and Vₜₕ₃ to the level of the rectified power V_{REC}. The controller 430 may control at least a portion of the first to third threshold voltages Vₜₕ₁, Vₜₕ₂ and Vₜₕ₃ compared to the voltage of the rectified power V_{REC} by the AC driver 420 or may control a time at which the respective switching elements SW1, SW2, SW3 and SW4 are turned on and turned off in the respective sections t1 to t8 of the single period of the rectified power V_{REC}, thereby controlling the level of light output by the light emitting unit 40, and the like.

Operations of the LED driving device 500 illustrated in FIG. 5 will be described with reference to FIGS. 6, and 8A to 8D. The rectified power V_{REC} generated by the rectifier 510 may be divided into a plurality of sections in a single period of the rectified power V. In sections t1 and t8 in which the voltage of the rectified power V_{REC} is higher than the reference potential (e.g., 0V) and is lower than the first threshold voltage Vₜₕ₁, the switching controller 525 may control the first and second switching circuits 521 and 523 so that the respective LED groups 51, 52, 53, and 54 are connected to one another in parallel as illustrated in FIG. 8A. In this case, a sum of currents flowing in the respective LED groups 51, 52, 53 and 54 may be defined as a constant current I1′.

In sections in which the voltage of the rectified power V_{REC} is higher than the first threshold voltage Vₜₕ₁ and lower than the second threshold voltage Vₜₕ₂, the first and second LED groups 51 and 52 may be connected to each other in series and the third and fourth LED groups 53 and 54 may be connected to each other in series as illustrated in FIG. 8B. Further, the first and second LED groups 51 and 52, and the third and fourth LED groups 53 and 54 may be connected to each other in parallel. In this case, a sum of currents flowing in the respective LED groups 51, 52, 53 and 54 may be defined as a constant current I2′. In sections in which the voltage of the rectified power V_{REC} is higher than the second threshold voltage Vₜₕ₂ and lower than the third threshold voltage Vₜₕ₃, the first, third and fourth LED groups 51, 53 and 54 may be connected to one another in series, and the second LED group 52 may be connected to the first LED group 51 in parallel as illustrated in FIG. 8C. In this case, a sum of currents flowing in the respective LED groups 51, 52, 53 and 54 may be defined as a constant current I3′.

In sections in which the voltage of the rectified power V_{REC} is higher than the third threshold voltage Vₜₕ₃ and is lower than the peak value Vₚₑₐₖ of the voltage of the rectified power V_{REC}, all of the LED groups 51, 52, 53 and 54 may be connected to one another in series, as illustrated in FIG. 8D. In this case, a sum of currents flowing in the respective LED groups 51, 52, 53 and 54 may be defined as a constant current I4′. For example, according to an exemplary embodiment, the LED groups 51, 52, 53 and 54 may constantly emit light, regardless of a change in a level of the rectified power V_{REC} within a single period thereof. However, a connection structure of the respective LED groups 51, 52, 53 and 54 may be changed depending on a change in a level within a single period of the rectified power V_{REC}. According to an exemplary embodiment, the levels of light output from the respective LED groups 51, 52, 53 and 54 may be substantially identical to each other.

According to an exemplary embodiment, the controller 530, which controls operations of the switching controller 525, based on a control command received according to the DALI communications protocol, may receive driving power for the operation thereof, from the switching controller 525. The switching controller 525 may compare a voltage of the rectified power V_{REC} to the first to third threshold voltages Vₜₕ₁, Vₜₕ₂ and Vₜₕ₃ to control operations of the first and second switching circuits 521 and 523. To this end, the switching controller 525 may include a circuit for generating predetermined first to third threshold voltages Vₜₕ₁, Vₜₕ₂, and Vₜₕ₃, and the controller 530 may receive driving power generated by at least one of the first to third threshold voltages Vₜₕ₁, Vₜₕ₂, and Vₜₕ₃. In this case, the driving power supplied to the controller 530 may also be supplied through a separate charger according to an exemplary embodiment illustrated in FIG. 3.

The controller 530 may control operations of the switching controller 525, based on the control command, to adjust a level of light output from the light emitting unit 50. According to an exemplary embodiment, the controller 530 may control at least a portion of the first to third threshold voltages Vₜₕ₁, Vₜₕ₂ and Vₜₕ₃ compared to the voltage of the rectified power V_{REC} through the switching controller 525 or may control a turn-on time and a turn-off time of switching devices included in the first and second switching circuits 521 and 523 in the respective sections of the single period of the rectified power V_{REC}, thereby controlling a level of light output from the light emitting unit 50, and the like.

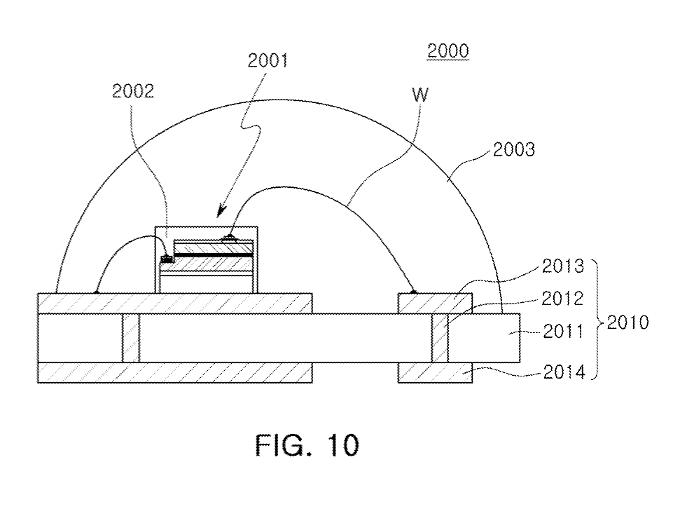

FIGS. 9 and 10 illustrate LED packages operated by the LED driving device according to an exemplary embodiment. The LED packages illustrated in FIGS. 9 and 10 may be included in at least one of the light emitting units 10, 20, 30, 40 and 50 of FIGS. 1 to 5.

With reference to FIG. 9, a semiconductor light emitting device package 1000 may include a semiconductor light emitting device 1001, a package body 1002, and a pair of lead frames 1003. The semiconductor light emitting device 1001 may be mounted on the lead frame 1003 to be electrically connected to the lead frame 1003 through a wire W. According to an exemplary embodiment, the semiconductor light emitting device 1001 may also be mounted on other regions instead of the lead frame 1003, for example, on the package body 1002. In addition, the package body 1002 may have a cup shape to improve light reflection efficiency. For example, a reflective cup may be provided with an encapsulation body 1005 formed thereon, the encapsulating body 1005 comprising a light transmitting material to encapsulate the semiconductor light emitting device 1001, the wire W, and the like.

With reference to FIG. 10, a semiconductor light emitting device package 2000 may include a semiconductor light emitting device 2001, a mounting substrate 2010, and an encapsulation body 2003. In an exemplary embodiment, a wavelength conversion unit 2002 may be formed on a surface and a side of the semiconductor light emitting device 2001. The semiconductor light emitting device 2001 may be mounted on the mounting substrate 2010 and electrically connected to the mounting substrate 2010 through a wire W and a conductive substrate (not shown).

The mounting substrate 2010 may include a substrate body 2011, an upper electrode 2013, and a lower electrode 2014. In addition, the mounting substrate 2010 may include a through electrode 2012, which connects the upper electrode 2013 and the lower electrode 2014 to each other. The mounting substrate 2010 may be provided as a substrate such as a printed circuit board (PCB), a metal-core printed circuit board (MCPCB), a multilayer printed circuit board (MPCB), a flexible printed circuit board (FPCB), or the like, and the structure of the mounting substrate 2010 may be variously applied.

The wavelength conversion unit 2002 may contain a phosphor, a quantum dot, or the like. An upper surface of the encapsulation body 2003 may have a convex, dorm-shaped lens structure to adjust an angle of beam spread in light emitted through the upper surface of the encapsulation body 2003, according to an exemplary embodiment. According to another exemplary embodiment, the surface of the encapsulation body 2003 may have a concave shaped lens structure.

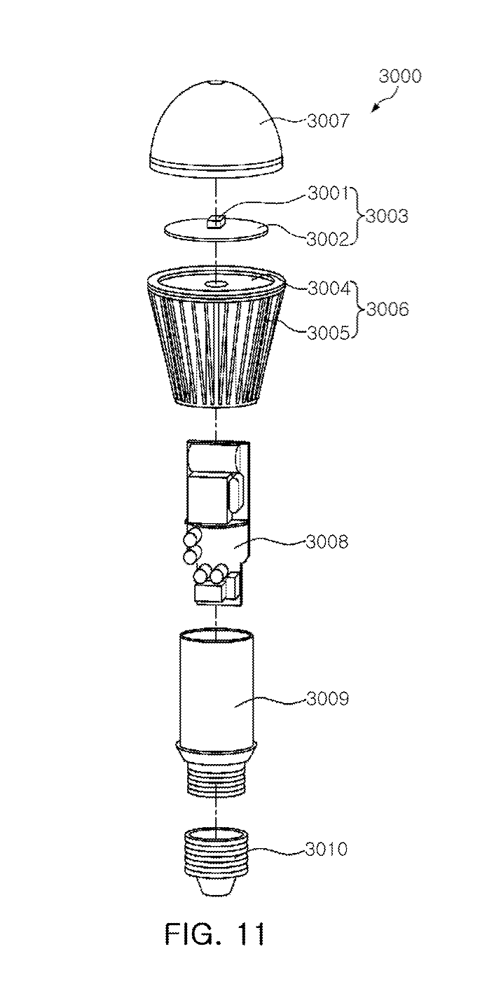

FIG. 11 an exploded perspective view illustrating an example in which an LED driving device according to an exemplary embodiment is applied to a lighting apparatus.

Referring to FIG. 11, a lighting apparatus 3000 may be a bulb type lamp by way of example. The lighting apparatus 3000 may include a light emitting module 3003, a driver 3008, and an external connection unit 3010. In an exemplary embodiment, the lighting apparatus 3000 may further include external and internal housings 3006 and 3009 and a cover unit 3007, which provide an exterior appearance of the lighting apparatus 3000. Although an exemplary embodiment describes the form in which a single semiconductor light emitting device 3001 is mounted on a circuit board 3002, a plurality of semiconductor light emitting devices as needed may be mounted on the circuit board 3002. In an exemplary embodiment, instead of directly mounting the semiconductor light emitting device 3001 on the circuit board 3002, the semiconductor light emitting device may be manufactured as a package type light emitting device and then mounted thereon.

In the lighting apparatus 3000, the light emitting module 3003 may engage with the external housing 3006 serving as a heat radiating unit, and the external housing 3006 may include a heat radiating plate 3004 directly contacting the light emitting module 3003 to improve a heat radiation effect. The external housing 3006 may further include a housing body 3005 connected with the heat radiating plate 3004. In an exemplary embodiment, the lighting apparatus 3000 may include the cover unit 3007 mounted on the light emitting module 3003 and having a convex lens shape. The driver 3008 may be installed in the internal housing 3009 to be connected to the external connection unit 3010, which has a structure such as a socket structure, to receive power from an external power supply. In an exemplary embodiment, the driver 3008 may convert the received power into a current source suitable for driving the semiconductor light emitting device 3001 of the light emitting module 3003 and supply the converted power. The driver 3008 may include at least one of the LED driving devices 100, 200, 300, 400 and 500 illustrated in FIGS. 1 to 5, and may receive a control command provided externally through the DALI communications protocol.

According to exemplary embodiments, an AC driver may drive an LED using rectified power output by a rectifier without a separate AC-DC converter. To provide driving power of a controller, which receives a control command through the DALI communications protocol to control luminance of the LED, a light emission time, setting for reservation thereof, and the like, rectified power, or DC power generated in a circuit of the AC driver may be used. Accordingly, an LED driving device may be simply implemented.

While exemplary embodiments have been shown and described above, it will be apparent to those skilled in the art that modifications and variations could be made without departing from the scope as defined by the appended claims.

What is claimed is:

1. A light emitting diode (LED) driving device for driving a plurality of LED groups, the LED driving device comprising:
a rectifier configured to rectify alternating current (AC) power to generate rectified power;
an AC driver configured to control respective operations of the plurality of LED groups based on a voltage of the rectified power; and
a controller configured to control an operation of the AC driver based on a control command received through a digital addressable lighting interface (DALI) communications protocol, and operate based on the rectified power received as driving power.

2. The LED driving device of claim 1, further comprising a voltage dropper configured to lower a voltage level of the rectified power to be supplied as the driving power.

3. The LED driving device of claim 1, wherein the AC driver compares a voltage of the rectified power to one or more threshold voltages within a single period of the rectified power and controls respective operations of the plurality of LED groups according to a result of the comparison.

4. The LED driving device of claim 3, wherein the controller controls light output from the plurality of LED groups by controlling the one or more threshold voltages.

5. The LED driving device of claim 3, wherein the controller divides the single period of the rectified power into a plurality of sections based on comparison between the voltage of the rectified power and the one or more threshold voltages, and controls light output from the plurality of LED groups by adjusting respective intervals of the plurality of sections.

6. The LED driving device of claim 1, wherein the AC driver increases a number of turned-on LED groups among the plurality of LED groups when the voltage of the rectified power is increased within a single period of the rectified power, and
the AC driver decreases the number of turned-on LED groups among the plurality of LED groups when the voltage of the rectified power is decreased within the single period of the rectified power.

7. The LED driving device of claim 1, wherein the AC driver increases a number of turned-on LED groups connected to one another in series, among the plurality of LED groups, when the voltage of the rectified power is increased within a single period of the rectified power, and
the AC driver increases the number of turned-on LED groups connected to one another in parallel, among the plurality of LED groups, when the voltage of the rectified power is decreased within the single period of the rectified power.

8. The LED driving device of claim 1, wherein the plurality of LED groups comprise a first LED group and a second LED group having different levels of light output therefrom when the same amount of a current is applied to the first and second LED groups, and the first LED group has a higher level of light output therefrom than that of the second LED group.

9. The LED driving device of claim 8, wherein the AC driver turns on the first LED group and the second LED group when the voltage of the rectified power is increased within a single period of the rectified power, and
the AC driver turns on the first LED group and turns off the second LED group when the voltage of the rectified power is decreased within the single period of the rectified power.

10. The LED driving device of claim 8, wherein the AC driver connects the first LED group and the second LED group to each other in series and turns on the first and second LED groups when the voltage of the rectified power is increased within a single period of the rectified power, and
the AC driver connects the first LED group and the second LED group to each other in parallel and turns on the first and second LED groups when the voltage of the rectified power is decreased within the single period of the rectified power.

11. A light emitting diode (LED) driving device for driving a plurality of LED groups, the LED driving device comprising:
a rectifier configured to rectify alternating current (AC) power to generate rectified power;
an AC driver configured to control respective operations of the plurality of LED groups, based on a voltage of the rectified power, and generate a predetermined direct current power; and
a controller configured to control an operation of the AC driver based on a control command received through a DALI communications protocol, and operate based on the direct current power received as driving power.

12. The LED driving device of claim 11, further comprising a charger being charged by the direct current power,
wherein the controller operates based on an output from the charger, which is supplied as the driving power.

13. The LED driving device of claim 11, wherein the AC driver compares a voltage of the rectified power to one or more threshold voltages within a single period of the rectified power and controls the respective operations of the plurality of LED groups according to a result of the comparison.

14. The LED driving device of claim 13, wherein the controller controls light output from the plurality of LED groups by controlling the one or more threshold voltages.

15. A lighting apparatus comprising:
a light emitting unit including a plurality of LED groups; and
an LED driving device configured to drive the plurality of LED groups by using alternating current (AC) power,
wherein the LED driving device comprises:
an AC driver including a plurality of switching elements connected to at least one of the plurality of LED groups, and a switching controller configured to control the plurality of switching elements based on comparison between a voltage of a rectified power generated by rectifying the AC power and one or more threshold voltages, and
a controller configured to control the switching controller based on a control command received through a DALI communications protocol, and operate based on the rectified power received as driving power.

16. The lighting apparatus of claim 15, wherein the switching controller controls the plurality of switching elements based on comparison between the voltage of the rectified power and the one or more threshold voltages in a single period of the rectified power.

17. The lighting apparatus of claim 15, wherein the AC driver divides the single period of the rectified power into a plurality of sections based on comparison between the voltage of the rectified power and the one or more threshold voltages.

18. The lighting apparatus of claim 17, wherein the switching controller sets a number of the switching elements that are turned-on in each of the plurality of sections.

19. The lighting apparatus of claim 17, wherein the switching controller turns on a different set of the switching elements in each of the plurality of sections.

20. The lighting apparatus of claim 16, wherein the switching controller determines a number of the LED groups being turned-on by controlling the switching elements.
